(19) United States
(12) Patent Application Publication
(10) Pub. No.: US 2005/0085934 A1
(43) Pub. Date: Apr. 21, 2005

(54) Computer system to output an external audio signal

(75) Inventor: Jae-min Jin, Incheon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/834,122

(22) Filed: Apr. 29, 2004

(30) Foreign Application Priority Data
Oct. 6, 2003 (KR) 2003-69067

(51) Int. Cl. G06F 17/00; G10L 11/00

(52) U.S. Cl. 700/94; 704/272

(57) ABSTRACT

A computer system including an audio controller receiving and amplifying an audio signal, and a speaker outputting the amplified audio signal. The computer system includes a power supply to supply the computer system with power; an external apparatus connection part to connect to an external apparatus connector which transfers the audio signal from an external apparatus; an external apparatus connection detector, supplied with the power from the power supply, to generate a connection detection signal if the external apparatus is connected to the external apparatus connection part; and a controller, supplied with the power from the power supply, to control the power supply to enable the power supply to supply the audio controller with the power on a basis of the connection detection signal of the external apparatus connection detector.

### CROSS-REFERENCE TO RELATED APPLICATIONS

This application claims the benefit of Korean Patent Application No. 2003-69067, filed Oct. 6, 2003, in the Korean Intellectual Property Office, the disclosure of which is incorporated herein by reference.

### BACKGROUND OF THE INVENTION

1. Field of the Invention

The present invention relates to a computer system, and, more particularly to, a computer system outputting an external audio signal amplified by the computer system through a speaker of the computer system even when the computer system is turned off.

2. Description of the Related Art

Today, the scope of usage of a computer system is not only limited to word processing or to simple data processing, but also to providing a user with various multimedia information by processing various multimedia information such as a graphic work, an image, and music.

Particularly, when the user tries to listen to music, he uses a compact disk-read only memory (CD-ROM) drive installed in the computer system to play audio signals stored in a separate compact disk (CD), or a particular application program to play a music file such as a MP3 file stored in a hard disk of the computer system.

Also, the user may use an audio playback device to amplify an external audio signal transferred from the audio playback device through the speaker by connecting the audio playback device to a connection terminal of the computer system.

FIG. 1 illustrates a configuration of a computer system in which an audio playback device is connected to a connection terminal of the computer system to play music. As shown therein, a computer system 1 comprises basic input/output apparatuses such as a monitor, a keyboard, and a touch pad; a hard disk drive installed inside a main body casing and storing files of information such an operating system (OS), and various application programs; a main board installed with a central processing unit (CPU), chipsets performing various operations such as graphic displaying, and a memory; and peripherals.

Particularly, the computer system 1 comprises an external apparatus connection part 25 to connect an external audio playback device 20 onto a side of a main body of the computer system, and a speaker 30 to output an audio signal amplified by the computer system.

FIG. 2 is a control block diagram of a conventional computer system to output an audio signal. As shown therein, the conventional computer system comprises a power supply 28 to supply power to the computer system, the external apparatus connection part 25, an audio controller 27 receiving and amplifying the audio signal, and the speaker 30.

With a configuration described above, if a user manipulates or pushes a power button to apply a power supply execution signal to boot the computer system, the power supply 28, receiving the power supply execution signal, supplies the power to a hard disk drive, a CPU, and all the devices installed inside the computer system. Accordingly, the computer system enters a state in which normal operations may be performed following a booting process.

Herein, the audio controller 27, which is supplied with the power, enables the computer system to amplify an audio signal from the external apparatus 20 connected to the external apparatus connection part 25 even before or after the operation of the computer system. Accordingly, the amplified audio signal is outputted through the speaker 30.

In this case, as long as the audio controller 27 and the speaker 30 function as an amplifier and a speaker, respectively, to amplify and output an external audio signal, the power supplied to the hard disk drive, the monitor, and the CPU in the state that the user does not use the computer system to perform any other job is unnecessarily wasted.

In other words, a disadvantage of a conventional computer system is that the audio signal provided by an external apparatus cannot be outputted through the speaker of the computer system unless the computer system is booted or operating normally.

### SUMMARY OF THE INVENTION

Accordingly, it is an aspect of the present invention to provide a computer system outputting an external audio signal amplified by a computer system through a speaker of the computer system even when the computer system is turned off.

The foregoing and/or other aspects of the present invention are achieved by providing a computer system comprising an audio controller receiving and amplifying an audio signal, and a speaker outputting the amplified audio signal, comprising: a power supply to supply the computer system with power; an external apparatus connection part to connect to an external apparatus connector, which transfers the audio signal from an external apparatus; an external apparatus connection detector, which is supplied with the power from the power supply, to generate a connection detection signal if the external apparatus is connected to the external apparatus connection part; and a controller, which is supplied with the power from the power supply, to control the power supply to enable the power supply to supply the audio controller with the power based upon the connection detection signal of the external apparatus connection detector.

According to another aspect of the invention, the external apparatus connection detector is a switch, provided on a circumference of the external apparatus connection part to generate the connection detection signal as the switch is turned on by connection of the external apparatus connector.

According to yet another aspect of the invention, the external apparatus connection detector detects a resistance value of the external apparatus connection part and generates the connection detection signal if the resistance value of the external apparatus connection part is a predetermined resistance value.

Additional and/or other aspects and advantages of the invention will be set forth in part in the description which follows and, in part, will be obvious form the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 illustrates a configuration of a computer system in which an audio playback device is connected to a connector of the computer system to play music;

FIG. 2 is a control block diagram of an audio signal output of a conventional computer system;

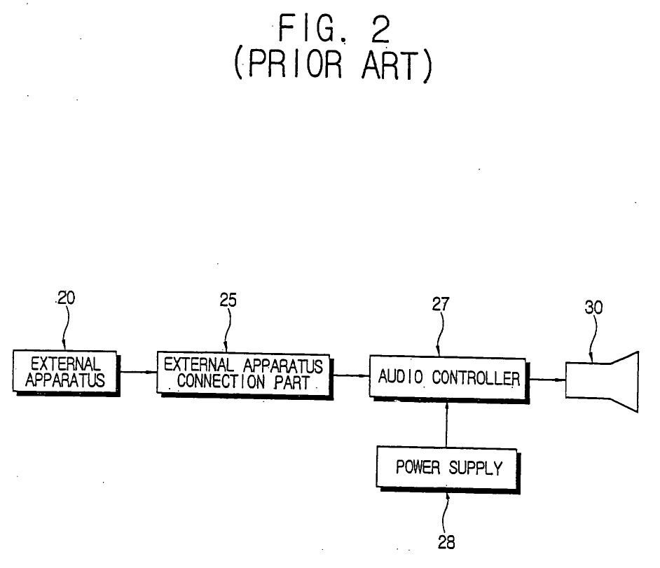

FIG. 3 is a control block diagram of an audio signal output of a computer system according to an embodiment of the present invention; and

FIG. 4 is a flow chart illustrating a process of outputting an audio signal of the computer system according to the embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

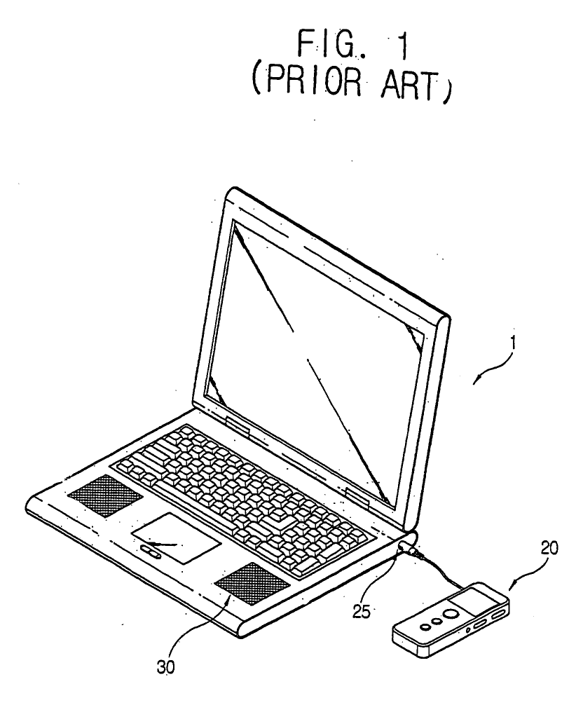

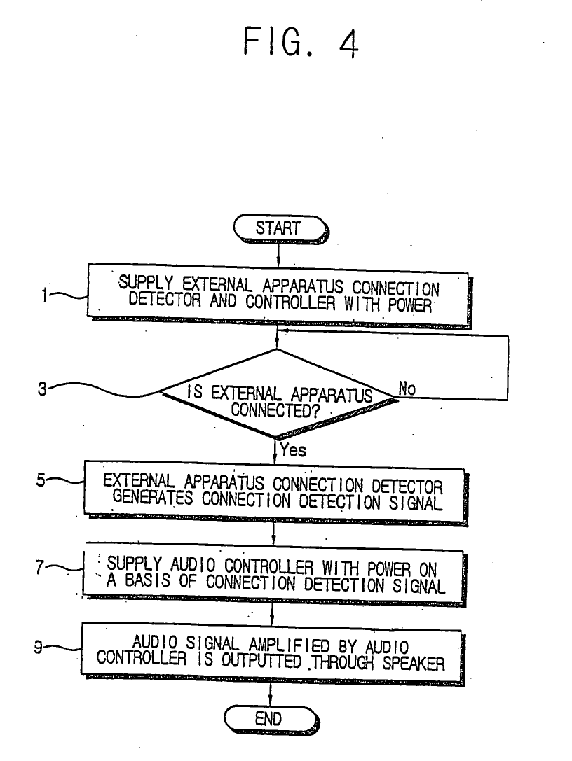

A computer system according to an embodiment of the present invention comprises input/output apparatuses, a main body having a hard disk drive and a main board installed therein, an external apparatus connection part 35 provided in the main body, and a speaker 40, as shown in FIG. 4. Additionally, the computer system is capable of connecting to an audio playback device via the connection terminal of the computer system illustrated in FIG. 1.

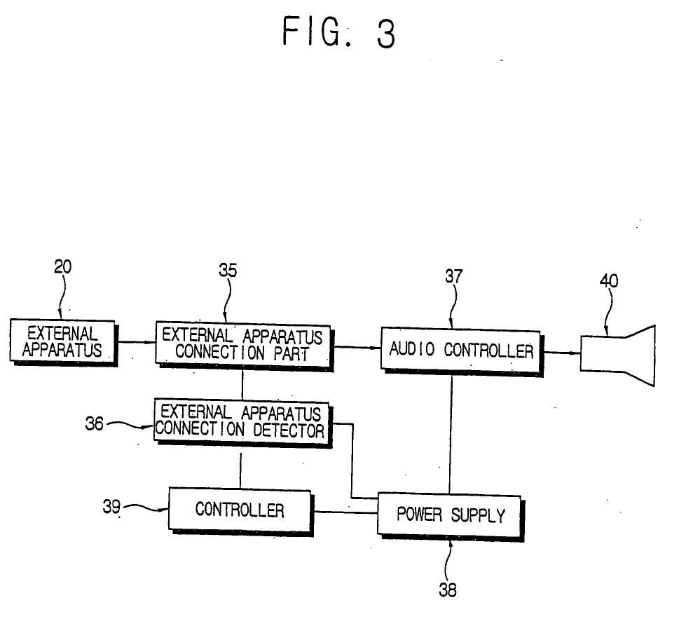

FIG. 3 is a control block diagram of an audio signal output of a computer system according to an embodiment of the present invention. The computer system according to the embodiment of the present invention comprises a power supply 38 to supply the computer system with power; an external apparatus connection part 35 connected with an external apparatus 20, which transfers an audio signal from the external apparatus 20; an external apparatus connection detector 36, which is supplied with the power from the power supply 38, to generate a connection detection signal if an external apparatus 20 is connected to the external apparatus connection part 35; an audio controller 37 to receive the audio signal to be amplified; a speaker 40 to output the amplified audio signal; and a controller 39, which is supplied with the power from the power supply 38, to control the power supply 38 to supply the audio controller 37 with the power based on the connection detection signal from the external apparatus connection detector 36.

Herein, the external apparatus 20 refers to an audio playback device to provide the computer system with an audio signal, which is amplifiable and playable by the computer system. As an example, a cassette player, a minidisc (MD) player, a CD player, an MP3 player, and a cellular phone may be categorized as the external apparatus 20.

The power supply 38 supplies not only the computer system with the power, but also the external apparatus connection detector 36 and the controller 39 described in the embodiment of the present invention with the power. In other words, the computer system supplies the external apparatus connection detector 36 and the controller 39 the power not only when the computer system operates normally in a normal mode, but also when the computer system is in a stand-by state, such as a saving mode or a power-off mode. This is true even though the power is not supplied to any other components of the computer system including peripheral devices. Accordingly, the computer system may amplify the audio signal by detecting a connection of the external apparatus even when the computer system is turned off.

The external apparatus connection part 35 is connected to an external apparatus connector provided in the external apparatus 20 to transfer the audio signal from the external apparatus 20. As an example, the external apparatus connection part 35 may be an audio terminal, such as a parallel port, or an USB port, which is capable of connecting with an audio jack.

The external apparatus connection detector 36, supplied with the power from the power supply 38, generates and outputs a connection detection signal to the controller 39 if the external apparatus is connected to the external apparatus connection part 35.

In an embodiment of the invention, the external apparatus connection detector 36 is a switch provided on a circumference of the external apparatus connection part 35 to generate the connection detection signal by being turned on by the connection of the external apparatus connector. As an example, the external apparatus connection detector 36 may be a switch, provided in the external apparatus connection part 35, to output a high state signal when not connected with the external apparatus connector of the external apparatus 20, and a low state signal when physically connected with the external apparatus connector of the external apparatus 20.

Also, the external apparatus detector 36 may detect a resistance of the external apparatus connection part 35 and may generate the connection detection signal if the resistance of the external apparatus connection part 35 is detected to be a predetermined value. As an example, the external apparatus connection detector 36 may be a connection detection circuit which detects and calculates a resistance value of a circuit which varies in a state in which the external apparatus connector is connected to the external apparatus detector 36 and in which the connection detection signal is generated if the detected and calculated resistance value varies from a predetermined resistance value.

The audio controller 37 receives and amplifies the audio signal while the speaker 40 outputs the amplified signal to the outside of the computer system in an acoustic waveform audible to the user. Meanwhile, the audio controller 37 and the speaker 30 used in the conventional computer system may be adopted for use in the embodiment of the present invention.

The controller 39, supplied with the power by the power supply 38, controls the power supply 38 to supply the audio controller 37 with power on a basis of the connection detection signal received from the external apparatus connection detector 36. In other words, the controller 39, receiving the connection detection signal, outputs the power supply signal to the power supply 38 to supply the audio controller 37 with power.

Hereinbelow, a process of outputting the audio signal of the computer system according to the embodiment of the present invention will be described in reference with FIG. 4.

In the computer system having a configuration shown in FIG. 3, the external audio signal may be outputted even if the power supply execution signal booting the computer system, caused by the manipulation of the user, is not applied.

Firstly, the external apparatus connection detector 36 and the controller 39 are supplied with the power by the power supply 38 at operation 1. Hence, the computer system is supplied with main power of AC power source regardless of an on/off status of the computer system.

If the external apparatus connector is connected to the external apparatus connection part 35 at operation 3, the external apparatus connection detector 36, having been supplied with power from the power supply 38, generates the connection detection signal at operation 5. The connection detection signal is outputted to the controller 39, which is also supplied with power from the power supply 38. Accordingly, the controller 39 outputs a predetermined power supply signal to the power supply 38. The fact that the controller 39 outputs a predetermined power supply signal to the power supply 38 enables the power supply 38 to supply the audio controller 37 with the power at operation 7.

The audio signal from the external apparatus 20 is transferred to the audio controller 37 through the external apparatus connection part 35, and the audio controller 37 amplifies the audio signal and outputs the amplified audio signal to the outside through the speaker 40 at operation 9.

With a configuration described above, a user may enjoy the music outputted from the speaker 40 as the external audio signal amplified by the computer system is outputted to the speaker 40 even when the computer system is turned off.

As described above, the embodiment of the present invention provides a computer system outputting an audio signal amplified by the computer system to a speaker of the computer system even when the computer system is turned off, by detecting connection of an external apparatus transferring the audio signal and by amplifying the audio signal.

Although a few embodiments of the present invention have been shown and described, it would be appreciated by those skilled in the art that changes may be made in this embodiment without departing from the principles and spirit of the invention, the scope of which is defined in the claims and their equivalents.

1. A computer system comprising an audio controller receiving and amplifying an audio signal, and a speaker outputting the amplified audio signal, comprising:
a power supply to supply the computer system with power;
an external apparatus connection part, which is connectable with an external apparatus connector, and which transfers the audio signal from an external apparatus;
an external apparatus connection detector, supplied with the power from the power supply, to generate a connection detection signal if the external apparatus is connected to the external apparatus connection part; and
a controller, supplied with the power from the power supply, to control the power supply to enable the power supply to supply the audio controller with the power based upon of the connection detection signal of the external apparatus connection detector.

2. The computer system according to claim 1, wherein the external apparatus connection detector is a switch, provided on a circumference of the external apparatus connection part, to generate the connection detection signal as the switch is turned on by connection of the external apparatus connector.

3. The computer system according to claim 1, wherein the external apparatus connection detector detects a resistance value of the external apparatus connection part and generates the connection detection signal if the resistance value of the external apparatus connection part is a predetermined resistance value.

4. The computer system according to claim 1, wherein the external apparatus comprises an audio playback device to provide the computer system with an audio signal, which is amplifiable and playable by the computer system.

5. The computer system according to claim 4, wherein the audio playback device is one of a cassette player, a minidisk player, a CD player, an MP3 player, and a cellular phone.

6. The computer system according to claim 1, wherein the external apparatus connection detector and the controller receive power both when the computer system operates in a normal mode and when the computer system is in a stand-by state.

7. The computer system according to claim 1, wherein the external apparatus connection part comprises a connection terminal.

8. The computer system according to claim 7, wherein the connection terminal comprises an audio terminal parallel port.

9. The computer system according to claim 7, wherein the connection terminal comprises a USB port, which is connectable with an audio jack.

10. A method to output an audio signal from an external apparatus of a computer system, which is turned off, the computer system including a speaker to output the audio signal, an external apparatus connection detector and a controller, comprising:
supplying power to the external apparatus connection detector and the controller;
determining if the external apparatus is connected to the computer system;
generating a connection detection signal, if the external apparatus is connected to the computer;
supplying an audio controller with power based on the connection detection signal; and
amplifying the audio signal.
